(19) United States
(12) Patent Application Publication
(10) Pub. No.: US 2013/0130864 A1
(43) Pub. Date: May 23, 2013

(54) STEERABLE UNITS AS A FRICTIONAL SURFACE BETWEEN OBJECTS

(71) Applicant: Ronald George Watts, Ottawa (CA)

(72) Inventor: Ronald George Watts, Ottawa (CA)

(21) Appl. No.: 13/475,661

(22) Filed: May 18, 2012

Related U.S. Application Data
(60) Provisional application No. 61/487,451, filed on May 18, 2011.

(51) Int. Cl. F16H 15/04; F16H 13/08; F16H 13/04

(52) U.S. Cl. CPC F16H 15/04; F16H 13/04; F16H 13/08
USPC 476/55; 476/67; 475/190

(57) ABSTRACT

Disclosed are steerable units that enable the variability of the friction force's magnitude and direction by using rolling contacts, in which the angle of the rolling contacts with respect to the surface containing the steerable unit can be controlled, as an object's frictional surface. This allows an object to adjust the direction and magnitude of the force it transfers through friction and also allows the received frictional force's direction and magnitude to be varied by the receiving object's rolling contacts. Also disclosed are applications of the steerable units in various machines.

### RELATED APPLICATION

This application claims priority to provisional application 61/487,451 filed May 18, 2011, the contents of which are incorporated herein by reference.

### FIELD OF THE INVENTION

The present invention generally relates to steerable units as a basic unit in a machine. More specifically, the invention relates to surfaces comprising steerable units, where the rolling components of the steerable unit can be angled with respect to surfaces comprising them, thus allowing the velocity of the surface with respect to another object to be controlled.

### BACKGROUND OF THE INVENTION

A simple transmission that increases torque and reduces RPM can be created by driving an input gear with less teeth than the driven output gear.

A simple standard transmission utilizes a configuration of several fixed gear sets with relevant gear ratio values.

This collection of gear sets broadens the range of vehicle velocities where an engine's power can be useable.

Moving between these fixed gear ratios requires varying the engine's RPM so it is not possible to continuously operate at an engine's most economic RPM with a standard transmission.

To allow an engine to run at its most efficient RPM requires a transmission with a continuum of suitable gear ratios that can be adjusted to the demand.

A continuously variable transmission (CVT) is a transmission which can change steplessly through an infinite number of effective gear ratios between maximum and minimum values.

Various forms of CVTs have been developed and are in commercial use today. However, the various designs typically suffer from one or more implementation issues that make them unsuitable for various applications.

A common friction drive CVT is the Variable Diameter Pulley (VDP) or Reeves drive. The distance between the pulleys does not change, and neither does the length of the belt. One of the v-belt pulleys narrows causing the belt on its side to ride higher and the other widens causing the belt on its side to ride lower. The simultaneously adjustments changes the effective diameters and gear ratio. With this type of CVT the minimum diameter is greater than zero and the max value is limited to the pulley's diameter.

Friction drives are the most common way to transfer power steplessly; however limited friction contact surface marginalizes the amount of power and torque they can handle.

CVTs provide only positive gear ratios and therefore require the additional mechanics for a reverse direction and high torque to cover the typical needs of a vehicle at a low velocity.

Ratcheting CVTs are another form of CVT; however this type typically suffers from vibration issues.

Another form of CVT is a Hydrostatic CVT or Hydristors, which typically utilize complex hydraulic/fluidic systems that have difficulties with fluid viscosity issues.

Traction drives, or rolling contact CVTs, are a form of stepless transmission that employs rolling-contact bodies. In these transmissions, power is transmitted in ways that depend on the rolling friction of bodies in the form of cylinders, cones, balls, rollers, and disks. Rolling contact CVTs utilize a rolling contact that varies output force by varying the distance between a rolling contact and the center of a rotating driven surface. The torque increases when the rolling contact is moved toward the driven surface's center. However, the ability to realize that torque depends on the transfer of force between the driver surface and the driven surface which decreases by a square proportion as you approach the driven surface's center.

Accordingly, in these transmission designs have issues with high torque because the more you try to transform velocity into torque so the less capable they are at transferring torque.

Furthermore, they do not allow the rolling contacts all the way to the center of the driven surface, so they can only transform power over a finite range with a velocity minimum greater than zero.

The invention overcomes the short coming's of all the other transmissions: contact surface area is not required to change so it can handle the maximum amount of torque, it can go to zero velocity, has no harmonic vibration issues and can change steplessly through an infinite number of effective gear ratios.

### SUMMARY OF THE INVENTION

According to an aspect of the present invention, there is provided a steerable unit for use in a machine. The steerable unit comprises an annulus for insertion into a surface of the machine; an axle transversing the annulus; and one or more rolling contacts positioned on the axle. The angle of the one or more rolling contacts in relation to the surface of the machine is controllable.

In one embodiment, the angle of the one or more rolling contacts in relation to the surface of the machine is controlled by rotating the axle about the center of the annulus.

In another embodiment, the angle of the one or more rolling contacts in relation to the surface of the machine is controlled by rotating the annulus within the surface of the machine.

In a further embodiment, the circumferential surface of the one or more rolling contact is capable of frictionally engaging another surface of the machine.

In a still further embodiment, the steerable unit further comprises a second annulus positioned within the annulus and slidable against the inner surface thereof, wherein the axle is attached to the inner surface of the second annulus.

In yet another embodiment, the angle of the one or more rolling contacts in relation to the surface of the machine is controlled by linkages, a radio frequency device or electric motors. The linkages can be ropes or pulleys.

In another embodiment, the one or more rolling contacts are made from synthetic or natural rubber. Alternatively, the one or more rolling contacts are electromagnetic.

In a further embodiment, the one or more rolling contacts are selected from spheres, wheels and cylinders.

In a still further embodiment, the two rolling contacts are positioned coaxially on the axle.

In an embodiment, the one or more rolling contacts positioned on the axle rotate about the axle. Alternatively, the rolling contacts and axle form a unitary structure and the axle rotates about a plane formed by the annulus.

According to another aspect of the present invention, there is provided a surface comprising one of more of the steerable units as described above.

According to a further aspect of the present invention, there is provided a chassis comprising two steerable units as described above. The chassis being crescent shaped and the two steerable units are positioned on the wings of the chassis.

According to an aspect of the present invention, there is provided a connecting system. The connecting system comprising: a first partially hollow cylinder dimensioned to receive a second partially hollow cylinder. The inner facing surface of the first partially hollow cylinder comprising a plurality of steerable units as described above, and the outer facing surface of the second partially hollow cylinder also comprising a plurality of steerable units. When the second partially hollow cylinder is engaged with the first partially hollow cylinder the plurality of steerable units on the inner facing surface of the first partially hollow cylinder frictionally engage the plurality of steerable units on the outer facing surface of the second partially hollow cylinder.

In one embodiment, the plurality of steerable units on the inner facing surface of the first partially hollow cylinder are positioned in a row around the circumference of the inner facing surface.

In a second embodiment, the plurality of steerable units on the outer facing surface of the second partially hollow cylinder are positioned in a row around the circumference of the inner facing surface.

In a third embodiment, three rows of the plurality of steerable units are positioned on the inner facing surface of the first partially hollow cylinder.

In a further embodiment, three rows of the plurality of steerable units are positioned on the outer facing surface of the second partially hollow cylinder.

In a still further embodiment, the outer facing surface of the partially hollow first cylinder comprises a plurality of steerable units as described above.

According to an aspect of the present invention, there is provided an epicyclic wheel system. The epicyclic wheel system comprising: a sun disc comprising an output shaft; a planet carrier comprising an input shaft; a set of one or more planet discs that receive rotational input from the planet carrier and engage the sun disc to rotate the output shaft; and an annulus surrounding the sun disc, planet carrier and the one or more planet discs, said annulus is dimensioned to interact with the circumferential surface of the planet discs. At least the circumferential surface of the one or more planet discs and the inward facing surface of the annulus comprise a plurality of steerable units as described above.

In another embodiment, the surface of the sun disc comprises a plurality of steerable units.

In a further embodiment, the angle of the rolling contacts in the plurality of steerable units of the one or more planet discs is independently controllable in relation to the angle of the rolling contacts in the plurality of steerable units on the annulus.

In a yet further embodiment, the angle of the rolling contacts in the plurality of steerable units of the one or more planet discs is independently controllable in relation to the angle of the rolling contacts in the plurality of steerable units on the annulus and the angle of the rolling contacts in the plurality of steerable units on the surface of the sun disc.

According to a further aspect of the present invention, there is provided a velocity modifier. The velocity modifier comprising: a plurality of interconnected epicyclic wheel systems as described above, each acting as a stage in the velocity modifier. Each stage has a velocity modifying factor and the input of each subsequent stage in the system is connected with the output of an immediately preceeding stage.

In one embodiment, the output shaft of one epicyclic wheel system acts as the input shaft for the adjacent epicyclic wheel system.

In a second embodiment, the immediately preceeding epicyclic wheel system and the subsequent epicyclic wheel system are serially interconnected such that the sun disc's shaft of the immediately preceeding stage is connected to an orthogonal disc connected to the annulus wheel of the subsequent stage.

According to a further aspect of the present invention, there is provided a continuously variable transmission. The continuously variable transmission comprising: a berth; a power input chassis configured to move in a first chassis direction in response to an input of mechanical power, and connecting to the berth; a rollable surface having an axis of rotation about which the rollable surface is rotatable, the rollable surface having a continuously variable angular orientation relative to the force direction of mechanical power input; the axis of rotation of the rollable surface may be oriented as substantially parallel to the first direction in which the power input chassis moves in response to the input of mechanical power, and connecting to the berth; a steerable rolling contact between the power input chassis and the rollable surface comprising the steerable unit as described above, the steerable rolling contact having a continuously variable angular orientation relative to the force direction of mechanical power input, and connecting to the berth; a power output land configured to move in a first land direction in response to an input of mechanical power, and connecting to the berth. The berth is rotatably configured to conduct mechanical power between a power input to a power output indifferent to whether the input and output points are the rollable surface, steerable rolling contact, chassis or land.

In one embodiment, the continuously variable angular orientation of the steerable rolling contact relative to the force direction of its mechanical power input is continuously variable 360 degrees or more.

In another embodiment, the continuously variable angular orientation of the rollable surface relative to the force direction of its mechanical power input is continuously variable 360 degrees or more.

In a further embodiment, the continuously variable transmission is configurable in a serial fashion where any immediately preceeding steerable rolling contact output is receivable by the next rollable surface or land in the series as input and where any immediately preceeding rollable surface output is receivable by the next steerable rolling contact or chassis in the series as input and vice versa.

In a still further embodiment, the contact with the berth comprises a rolling contact.

In a yet further embodiment, the rolling contact between the power output land and the rollable surface is a steerable rolling contact.

In another embodiment, the power input chassis, the rollable surface and the power output land are arranged in a circular configuration so that the rollable surface has a substantially toroidal shape.

In a further embodiment, the continuously variable transmission further comprises a sprocket arranged around an exterior of the circular configuration of the power output land.

In a still further embodiment, the steerable rolling contact between the power input chassis and the rollable surface comprises a plurality of steerable rolling contacts.

In a yet further embodiment, the rollable surface is rotatable around its axis of rotation within the berth of the power output land, but is restrained from movement in the first direction.

In another embodiment, the steerable rolling contact comprises a plurality of steerable wheels integrated onto the rollable surface.

In a further embodiment, the rollable surface having the plurality of steerable wheels integrated thereon is integrated as part of the power input chassis.

According to another aspect of the present invention, there is method of controlling the velocity of moving parts in a machine. The method comprising the steps of: providing an input velocity to an input chassis; moving said input chassis with respect to an output chassis to transfer the velocity to the output chassis, wherein the surface of the input chassis that contacts the output chassis or the surface of the output chassis that contacts the input chassis or both comprising the steerable units as described above; and outputting the velocity of the output chassis as power. The angle of the wheels of the steerable units in relation to input chassis or output chassis or both controls the rotational velocity of the output chassis.

In one embodiment, the step of moving the input chassis with respect to the output chassis involves rotating the input chassis in relation to the output chassis.

### BRIEF DESCRIPTION OF THE DRAWINGS

These and other features, aspects and advantages of the present invention will become better understood with regard to the following description and accompanying drawings wherein:

FIG. 1 (a) shows an embodiment of the steerable unit of the present invention, (b) shows a top plan view of this embodiment; (c) shows an embodiment of the steerable unit of the present invention, (d) shows a top plan view of this embodiment; (e) shows an embodiment of the steerable unit of the present invention, and (f) shows a top plan view of this embodiment;

FIG. 2 (a) shows an embodiment of the steerable unit of the present invention, and (b) shows a top plan view of this embodiment;

FIG. 3 (a) shows an embodiment of the steerable unit of the present invention in a surface of a machine, (b) shows a top plan view of the steerable unit with the rolling contacts at one angle with respect to the surface of the machine, and (c) shows a top plan view of the steerable unit with the rolling contacts at another angle with respect to the surface of the machine;

FIG. 4 (a) shows a surface comprising a steerable unit according to an embodiment of the invention; (b) shows a perspective view of two juxtaposed surfaces, each having a steerable unit; (c) shows a surface comprising the steerable unit wherein the rolling contacts are angled 45 degrees away from the y-axis; (d) shows a surface comprising the steerable unit wherein the rolling contacts are angled 90 degrees away from the y-axis; and (e) shows a surface comprising the steerable unit wherein the rolling contacts are angled 135 degrees away from the y-axis;

FIGS. 5 and 6 are vector diagrams illustrating the change in magnitude and direction of the velocity component, applied to a chassis, to result in translational movement of the land relative to the chassis in accordance with an embodiment of the present invention;

FIGS. 7 to 15 are various illustrations of linear configurations of continuously variable transmissions (CVTs) in accordance with embodiments of the present invention;

FIGS. 16 to 18 are illustrations of circular configurations of the linear CVT segments of FIGS. 7 to 15;

FIG. 19 is an illustration of a circular transmission system designed for use on a bicycle in accordance with an embodiment of the present invention;

FIG. 20 is an illustration of a connecting system according to an embodiment of the present invention; and

FIG. 21 is an illustration of an epicyclic system according to an embodiment of the present invention.

### DESCRIPTION OF THE INVENTION

The following description is of an embodiment by way of example only and without limitation to the combination of features necessary for carrying the invention into effect.

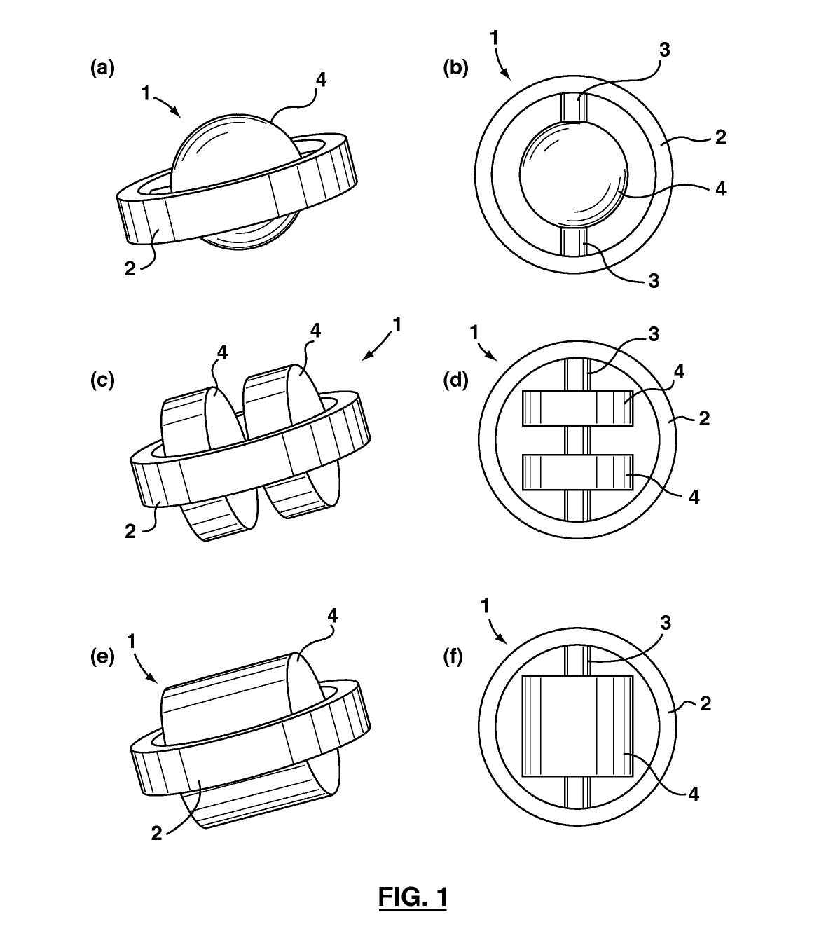

The present invention relates to a steerable unit for use in a machine. As shown in FIG. 1, the steerable unit (1) comprises an annulus (2), an axle (3) transversing the annulus (2) and one or more rolling contacts (4) positioned on the axle (3).

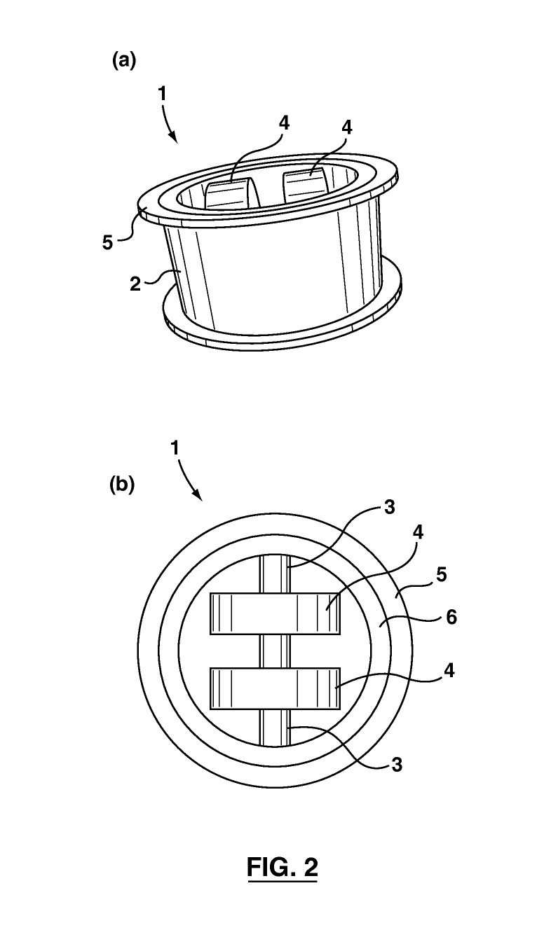

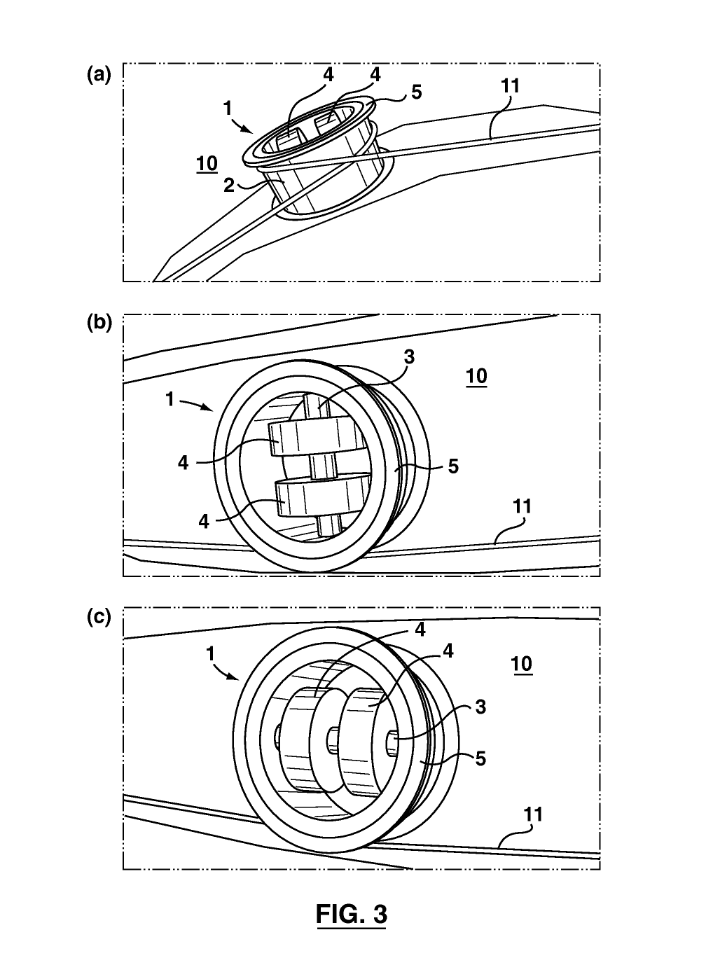

The steerable unit (1) comprises an annulus (2) that surrounds the rolling contacts (4). The height of the annulus (2) can vary, as shown in FIGS. 1a and 2a, for example. Typically, the height of the annulus (2) will be equal or greater than the thickness of the surface of the machine that the steerable wheel (1) is inserted. In one embodiment, the angle of the rolling contacts (4), with respect to the surface (10) of the machine, is controlled by wrapping a rope or wire (11) around the annulus (2) (FIG. 3). In this case, the annulus (2) can be provided with a height that is greater than the thickness of the surface (10) of the machine, or positioned within the surface (10) of the machine so that a portion of the annulus (2) extends beyond the surface (10) of the machine. As shown in FIG. 3, this arrangement allows for a rope or wire (11) to be wrapped around the annulus (2). To prevent the wire or rope (11) from sliding along the annulus (2) and off the steerable unit (1) altogether, an outwardly extending flange (5) can be advantageously provided on one or both ends of the annulus (2) (see FIGS. 2a and 3).

Pulling on one end of the rope or wire (11) will cause the annulus (2) to rotate clockwise, with respect to the surface (10) of the machine. Whereas pulling the opposite end of the rope or wire (11) will cause the annulus (2) to rotate counter clockwise, with respect to the surface (10) of the machine. In the embodiment where the rotation of the axle (3) is directly connected with the rotation of the annulus (2), pulling the rope or wire (11) will rotate the angle of the rolling contacts (4) with respect to the surface (10) of the machine. As described below, controlling the angle of the rolling contacts (4) with respect to the surface (10) of the machine allows for an object to adjust the direction and magnitude of the force it transfers through friction and also allows the received frictional force's direction and magnitude to be varied by the receiving object's rollable surface.

The annulus (2) can be made of any number of substances, including, but not limited to, titanium, aluminum, and carbon fiber. The annulus (2) can be made of the same, or similar, substance to the surface (10) of the machine. However, it may be advantageous to provide the annulus (2) in a substance that can resist damage to heat, including heat transfer, since, in operation, the rotational velocity of the rolling contacts (4) could produce significant heat.

The axle (3) of the steerable units (1) transverse the annulus (2) and typically pass through the center of the annulus (2). In one embodiment, the axle (3) is directly connected on either end to the inner surface of the annulus (2). In this particular arrangement, as shown in FIGS. 3b and 3c, rotation of the annulus (2) directly rotates the axle (3) about the center of the annulus (2). In an alternate embodiment, the axle (3) is connected on either end to the inner surface of a second annulus (6) provided within the interior space defined by the annulus (2) (FIGS. 2a and 2b). This arrangement allows for the second annulus (6) and connected axle (3) to be rotated independently of the annulus (2). Alternatively, a track or channel (not shown) can be provided on the inner surface of the annulus (6), so that the axle (3) is free to rotate about the center of the annulus (6), while the annulus (6) remains stationary. In this case, stops, such as bosses or the like, may be provided along the track to retain the axle (3) at different positions within the track.

Rolling contacts (4) are provided on the axle (3). In some embodiments, such as those shown in FIGS. 1a, b, e, and f, a single rolling contact (4) is provided on the axle (3). In other embodiments, such as that shown in FIGS. 1c and d, more than one rolling contact (4) can be provided on the axle (3). Although the figures provided herewith show a maximum of two rolling contacts (4) on an axle (3), the actual maximum number of rolling contacts (4) is only limited by the length of the longitudinal axis of the axle (3) and the width of the rolling contact (4).

As shown in FIG. 1, the actual shape of the rolling contact (4) can be any round shape, such as, but not limited to, spherical, wheel shaped or cylindrical, that can rotate in a circular pattern about the axle (3). In the case of wheels, the actual structure of the wheel can be solid, semi-solid, or a traditional spoke and rim design.

At least the circumferential surface of the rolling contact(s) (4) are preferable made from a material that can transfer force, like friction, and engage another surface of the machine, including, but not limited to, the circumferential surface of another rolling contact (4). Examples of such friction force transfer materials include, but are not limited to, natural rubber, synthetic rubber, natural and synthetic resins, and polymers. In other applications, the rolling contact(s) (4) can be made from materials having a low coefficient of friction. In this case, the rolling contacts (4) can frictionally engage another surface of the machine by applying a compressive force against the circumferential surface of the rolling contact (4). Such a compressive force could be achieved by either moving the steerable unit (1) in the direction of the surface of the machine or by pressing the surface of the machine against a stationary steerable unit (1). In another embodiment, the rolling contacts (4) can be made to be electromagnetic, so that the rotational velocity of the rolling contact (4) is controlled by the force between a charged rolling contact (4) and a similarly charged surface of the machine. In this case, a material with a low coefficient of friction, such as a metal, may be preferably used to manufacture the rolling contact (4).

In one embodiment, the rolling contact (4) forms a unitary structure with the axle (3), such that rotation of the axle (3) about its longitudinal axis causes the rolling contacts (4) to rotate about the same axis. In this case, a rotatable contact between the axle (3) and the annulus (2) or second annulus (6) is required to allow for the axle to rotate. In another embodiment, the rolling contact(s) (4) rotate about the longitudinal axis of the axle (3) while the axle (3) remains stationary along this axis.

To illustrate an aspect of the present invention, the following scenario shows how, a driver steerable unit (1) used as the friction contact between a surface (10) of a machine and another object, transforms a force's magnitude but not necessarily its direction.

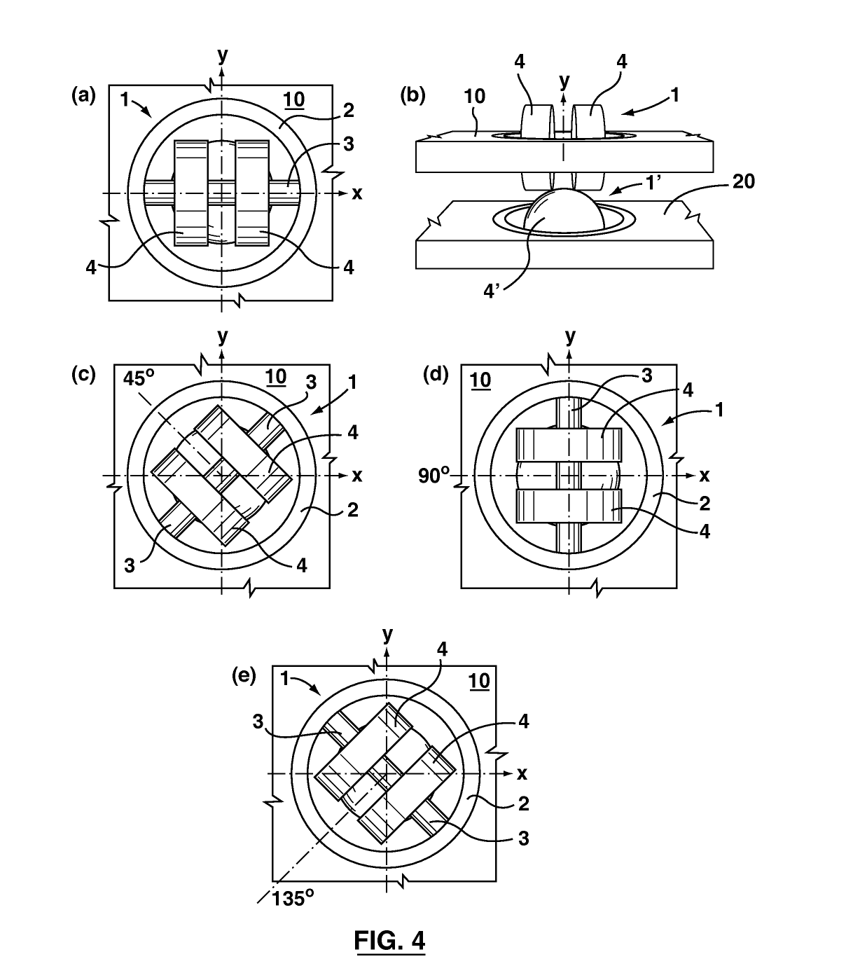

With reference to FIG. 4, the steerable units (1) described hereinabove at time zero are motionless and parallel with the imaginary y-axis shown in FIG. 4a. For the purposes of this discussion, the term “right” refers to motion along the positive x-axis and the term “left” refers to motion along the negative x-axis.

The rolling contacts (4) of the steerable unit (1) when turned exert a force with both an x and y component to the object in which the surface (10) with steerable units (1) is engaged. The object exerts an equal and opposite force, through the axle (3), to the steerable unit (1), and surface (10) containing the steerable unit (1) changing its velocity and direction.

If the transfer of force along the x axis is denied, then only the y component of the force is transmitted. In this case the magnitude and direction of the force's y component is proportional to the amount the rolling contacts (4) are turned and the steerable unit (1) and surface (10) would only move along the y axis.

If the object in which the rolling contacts (4) of the steerable unit (1) are engaged itself were able to spin freely in either positive or negative x direction, driven, then it would deny the transfer of force along the x axis, while providing friction along the y axis. This type of object (20) would be analogous to itself being another steerable unit (1′) with its axle aligned along the y axis (FIG. 4b).

When moving along this object (20) and the rolling contacts (4′) are not turned from the y direction, the surface (10) velocity and direction are what would be expected from the rolling contacts (4) of the steerable unit (1).

As shown in FIG. 4c, if the rolling contacts (4) of the steerable unit (1) are steered left, 45 degrees from the y axis, the surface's (10) velocity is reduced but its direction along the y axis is unchanged. There is no power loss so any decrease in velocity means a proportional increase in torque.

As shown in FIG. 4d, when the rolling contacts (4) are turned further to 90 degrees left of the y-axis, then the surface (10) and steerable unit (1) will be stationary at a zero velocity.

As the rolling contacts (4) are turned even further to 135 degrees left of the y axis, the surface (10) with steerable unit (1) travels rearward (in the negative y) direction with velocity magnitude the same as the 45 degree turn (FIG. 4e).

Steering the rolling contacts (4) until angled 180 degrees, the surface (10) with the steerable unit (1) will be travelling at the original velocity magnitude but rearward.

By varying the angle of the rolling contacts (4) of the steerable unit (1) from 0 to 180 degrees to the object (20) with steerable unit (1′), which is also capable of rotating, it is possible to vary the surface's (10) velocity continuously from 100% to 0% to −100%, inclusive without affecting its direction along the x axis. Because there is no power loss the torque proportionally increases as the absolute value of velocity decreases.

In one embodiment, an input velocity is modified by a driven steerable unit and its output velocity modified by a successive driven steerable unit.

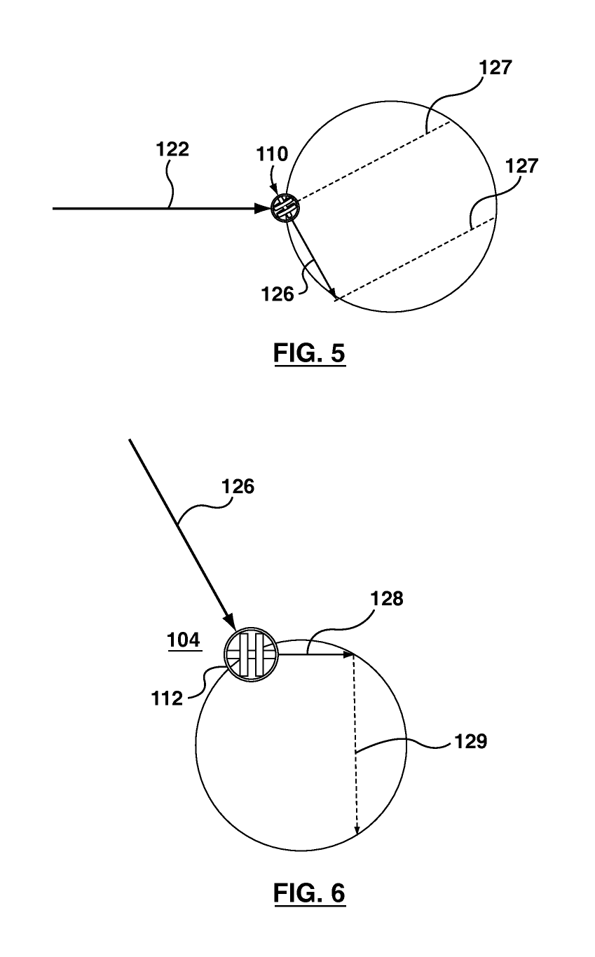

FIGS. 5 and 6 are vector diagrams of driven rolling contacts, illustrating the chassis 102, or surface comprising a steerable unit as described above, velocity vector's change in magnitude and direction by two successive rolling contacts, 110 and 112. Resulting in the movement of the land 104, or object as previously described, in the same direction relative to the chassis 102 but with an increased torque and reduced velocity.

In FIG. 5 it has been assumed that the rolling contacts 110 are in the 30 degree orientation. However, this is merely for illustrative purposes, and the same analysis is valid for any multiple of any angular orientation between 0 and 90 degrees.

As force is applied to the chassis 102, the chassis 102 begins to move, which means that the rolling contacts 110 have a velocity vector 122.

Because the rolling contacts 110 are in rolling contact with the rolling contacts 112, of FIG. 6, the input velocity vector 122 can be decomposed into two components: a velocity vector 126 along the axis of rotation of the rolling contacts 110 and a velocity vector 127 perpendicular to the axis of rotation of the rolling contacts 110.

The velocity vector 126 and the velocity vector 127 should sum vectorily to equal the input velocity vector 122 if losses are ignored.

The velocity vector component 127 perpendicular to the axis of rotation of the rolling contacts 110 is “spun off” by the rotation of the rolling contacts 110, and is not transferred, but the velocity vector 126 parallel to the axis of rotation of the rolling contacts 110 is transmitted to the rolling contacts 112 of FIG. 6.

It can be seen that if the input velocity vector 122 is assumed to have a magnitude ω₁, then the magnitude ω₂ of the velocity vector 126 is given by:

ω₂=ω₁×sin(α₁), (8)

where α₁ is the angular orientation of the rolling contacts 110, to a line parallel with the direction of the input velocity vector 122, which in the illustrated example is 30 degrees.

With reference to FIG. 6, it can be seen that the velocity vector 126 applied to the rolling contacts 112 in the berth on the land 104 can be decomposed into two components: a velocity vector 128 along the axis of rotation of the rolling contacts 112, and a velocity vector 129 perpendicular to the axis of rotation of the rolling contacts 112.

The velocity vector 128 and the velocity vector 129 should sum vectorily to equal the velocity vector 126 if losses are ignored.

The velocity vector component 129 perpendicular to the axis of rotation of the rolling contacts 112 is “spun off” by the rotation of the rolling contacts 112.

The velocity vector component 128, parallel to the axis of rotation of the rolling contacts 112, is transmitted through the rolling contacts' 112 contact to the berth's contact to the land 104.

With further reference to FIG. 6, it can be seen that if the velocity vector 126 is assumed to have a magnitude ω₂, then the magnitude ω₃ of the velocity vector 128 is given by:

ω₃=ω₂×sin(α2). (9)

In the illustrated example, the angular orientation of the rolling contacts 110, FIG. 5, and steerable wheels 112, FIG. 6, is shown as both being a 30 degree orientation. In this case the decrease in magnitude of the input velocity vector would be equal to:

$$\frac{{ω}_{3}}{{ω}_{1}} = {sin}^{2} ( {α}_{1} ) = {sin}^{2} ( 30 ) = {( 0.5 )}^{2} = 0.25 .$$

Due to the law of conservation of power, this means a four fold increase in the force component regarding output power.

The ability to realise the increase in torque depends on what is the maximum frictional force between the rolling contacts. In an embodiment, an increase in pressure pushing the rolling contacts together can create such a force.

The ability to practically transfer force by friction is related to stable contacting area between objects. The contact area in this approach is unchanged.

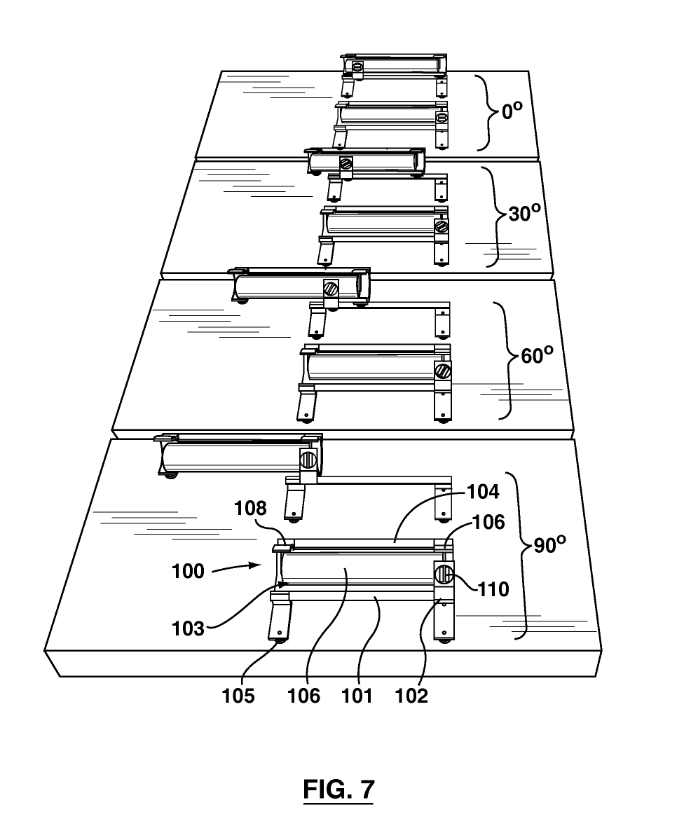

An example of a continuously variable transmission (CVT) in a linear configuration in accordance with an embodiment of the present invention will now be described with reference to FIGS. 7 to 15.

FIG. 7 is an illustration of the operation of a CVT 100 in a linear configuration in accordance with an embodiment of the present invention, in which the operation is shown for four different angular settings (90, 60, 30 and 0 degrees) of the rolling contacts of the steerable units.

The CVT 100 shown in FIG. 7 includes two main elements: a “vehicle” element 101 that includes a chassis 102 and a “land” element 104.

The land 104 includes a berth 108 in which a steerable unit 106 is installed.

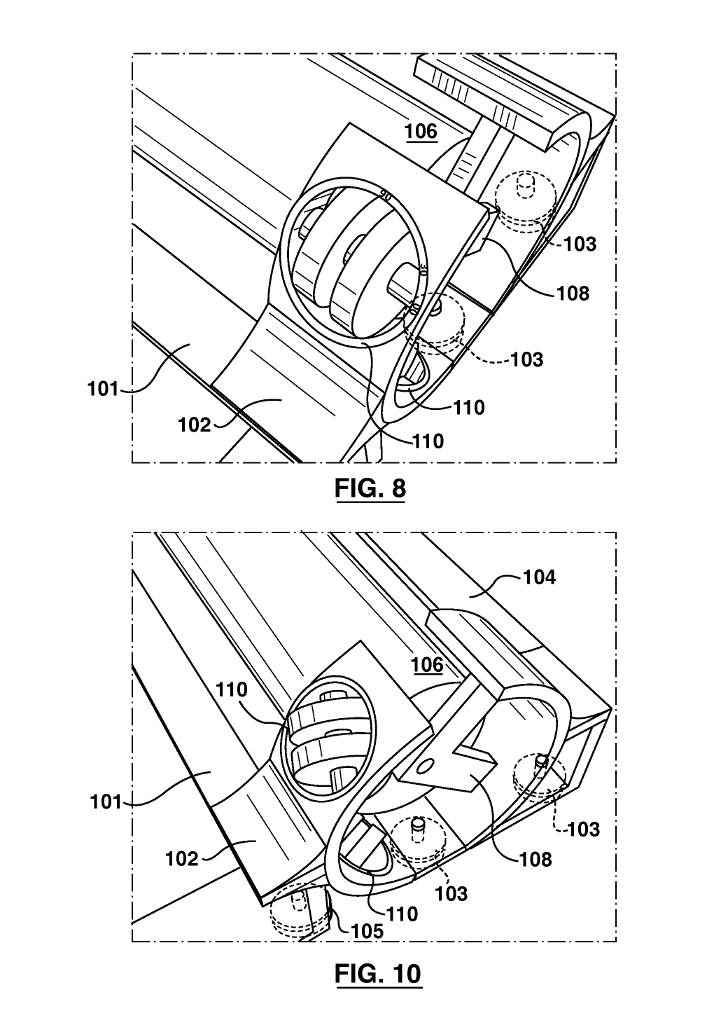

The chassis 102 has two pairs of steerable units 110 (See FIGS. 8 to 15—only one of the pair is visible in FIG. 1) that are in rolling contact with the steerable unit 106. The steerable units 110 are configured so that they have a zero turning radius within their housing in the chassis 102. The steerable units, in this arrangement, are preferred positioned on the wings of the chassis.

The chassis 102 is slidably mounted on the vehicle 101 so that the chassis 102 can be moved along the length of the vehicle 101 by applying a force to the chassis parallel to the axis of rotation of the rolling contacts in steerable unit 106.

The land 104 is mounted on wheels 103 so that the land is able to move over the surface on which it is placed. Similarly, the vehicle 101 is also mounted on wheels 105.

The rolling contact between the steerable units 110 and the steerable unit 106 allows for power transmission from the chassis 102 to the land 104. The angle of the rolling contacts in steerable wheels 110 relative to the axis of rotation of the rolling contacts in steerable unit 106 determines how much of the force that is applied to the chassis 102 is transferred to the land 104.

The angular orientation of the rolling contacts of the steerable units 110 relative to the axis of rotation of the rolling contacts of steerable unit 106 can be varied continuously through at least 0 to 90 degrees. As noted above, FIG. 7 illustrates operation of the CVT 100 for four different orientations of the rolling contacts of the steerable units 110. In each case, force is applied to the chassis 102 in order to move the chassis from right to left along the length of the vehicle 101.

In the first of these orientations, the rolling contacts of the steerable units 110 are angled at 90 degrees to the direction of force applied to the chassis 102. That is, the axis of rotation of the rolling contacts of the steerable units 110 is parallel to the axis of rotation of the rolling contacts of the steerable units 106 and to the direction of force applied to the chassis 102. In this configuration, as force is applied to the chassis 102, which causes the chassis 102 to move along the length of the vehicle 101, because the rolling contacts of the steerable units 110 are aligned 90 degrees (perpendicular) to the applied force and parallel to the axis of rotation of the rolling contacts of the steerable unit 106, the steerable units 110 do not move relative to the steerable units 106. As such, the steerable unit 106, and the land 104, which the steerable unit is connected to via the berth 108, are moved in the same direction as the movement of the chassis 102 and are moved the same amount as the chassis.

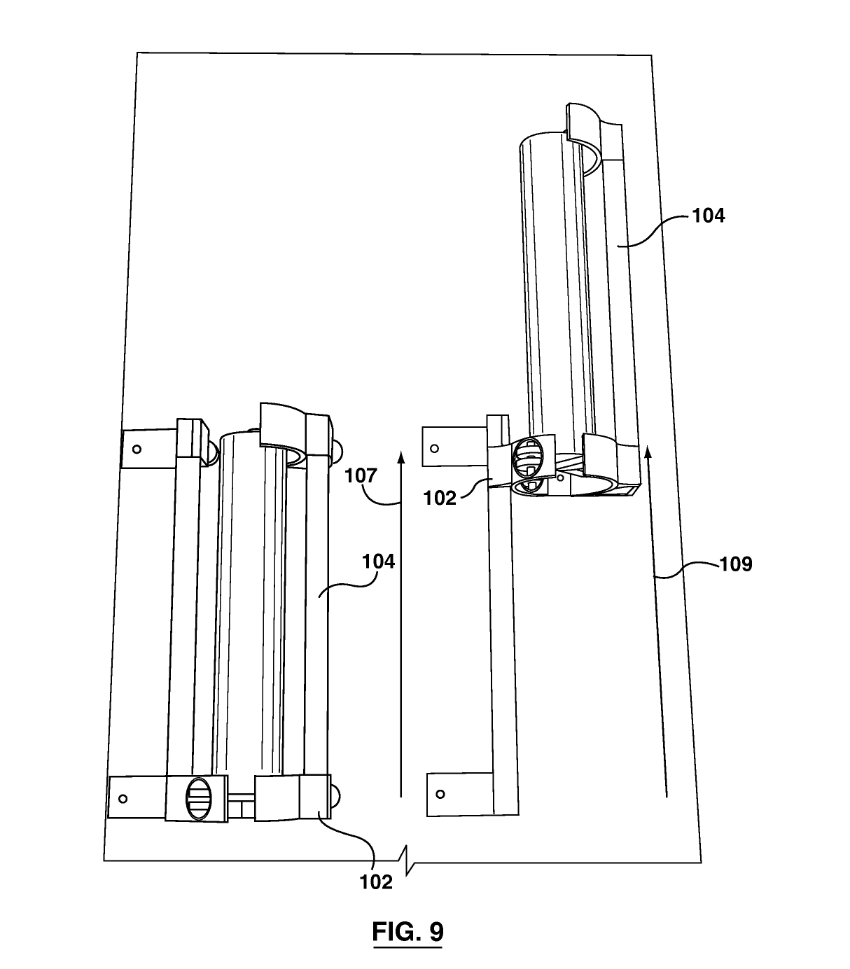

Perspective views of the operation of the 90 degree orientation are shown in FIGS. 8 and 9.

As can be seen in FIG. 9, in the 90 degree orientation, the movement of the chassis 102 a distance 107, causes a movement of the land 104 an equal distance 109. In other words, the 90 degree orientation of the rolling contacts of steerable unit 110 relative to the direction of applied force causes the land 104 to move the same distance in the same amount of time as the chassis 102, which means that the velocity and force components of the input power are equal to the velocity and force components of the output power (ignoring frictional losses).

In the second and third orientations, the rolling contacts of steerable units 110 are angled at 60 degrees and 30 degrees respectively to the direction of force applied to the chassis 102. That is, the axis of rotation of the rolling contacts of steerable units 110 is 30 degrees and 60 degrees respectively from parallel to the axis of rotation of the rolling contacts of steerable unit 106 and to the direction of force applied to the chassis 102 in these two configurations. In these configurations, as force is applied to the chassis 102 causing the chassis 102 to move along the length of the vehicle 101, because the axis of rotation of the rolling contacts of steerable units 110 is not parallel to the direction of movement of the chassis 102, the rolling contacts of steerable units 110 will rotate and translate with respect to the rolling contacts of steerable unit 106, which means that of the force applied to the chassis 102, only the portion of the force that is parallel to the axis of rotation of the rolling contacts of steerable units 110 will be transferred through the rolling contact between the rolling contacts of steerable units 110 and the rolling contact of steerable unit 106 to the land 104. That is, the amount of force transferred to the land 104 through the rolling contact between the rolling contact of steerable units 110 and the rolling contacts of steerable unit 106 from the force applied to the chassis 102 varies with the change in angular orientation of the rolling contact of steerable units 110.

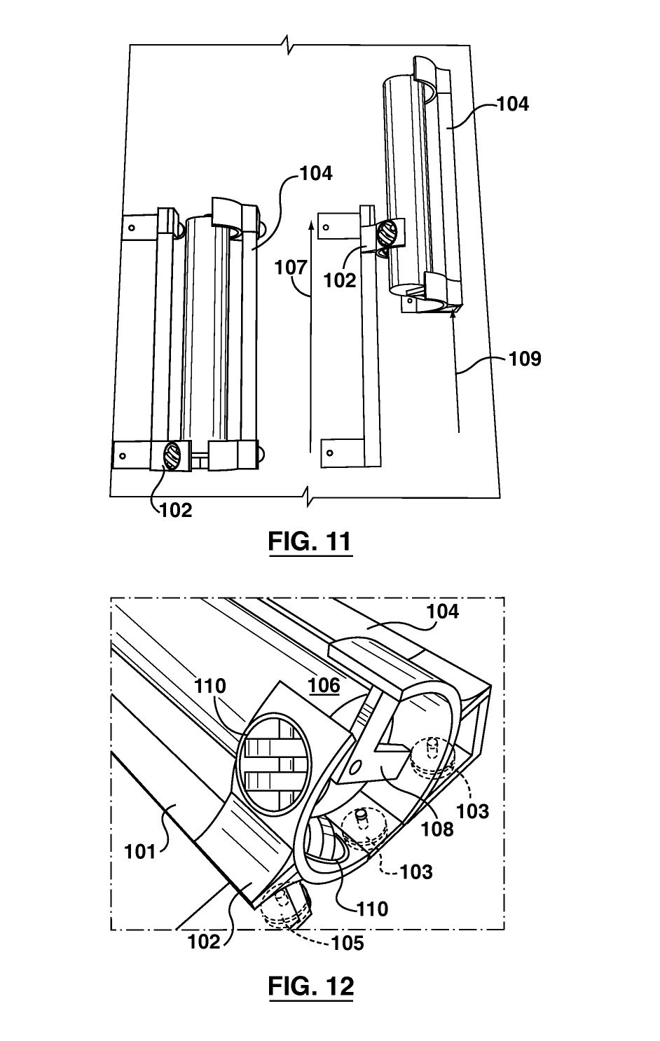

Perspective views of the operation of the 60 degree orientation are shown in FIGS. 10 and 11.

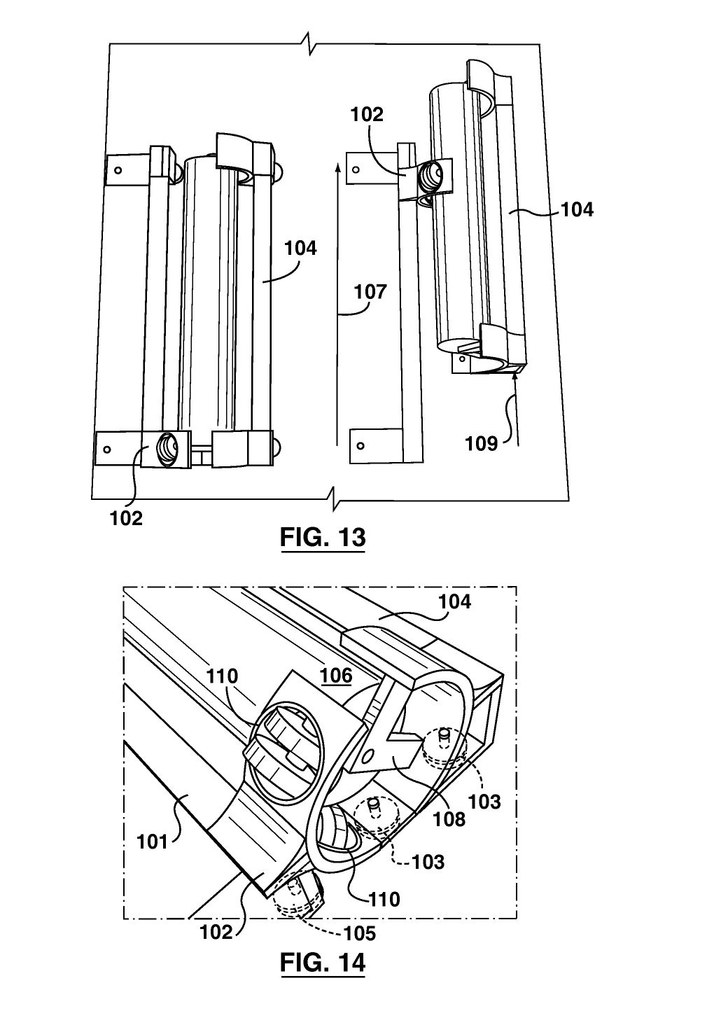

Perspective views of the operation of the 30 degree orientation are shown in FIGS. 12 and 13.

It can clearly be seen in FIGS. 9, 11 and 13 that movement of the chassis 102 a distance 107 in the 90 degree orientation resulted in movement of the land 104 a distance 109 equal to the distance 107 moved by the chassis, while in the 60 degree orientation, and to an even greater extent in the 30 degree orientation, the distance 107 moved by the chassis results in a lesser distance 109 moved by the land 104. In other words, although the chassis 102 was moved the same distance 107 in each case, the distance 109 moved by the land 104 decreases for the 60 degree orientation and still further for the 30 degree orientation. As the land 104 is now moving over less distance in the same amount of time, the output velocity of the land 104 is decreased. However, due to the law of conservation of power and energy, the output force from the land 104 is proportionally increased.

In the fourth orientation, the rolling contacts of steerable units 110 are angled at 0 degrees to the direction of force applied to the chassis 102. That is, the axis of rotation of rolling contacts the steerable units 110 is 90 degrees from parallel to the axis of rotation of the rolling contacts of steerable unit 106 and to the direction of force applied to the chassis 102 in the fourth configuration. As such, in this configuration, any force applied to the chassis 102 will cause the chassis to move without imparting any force to the land 104, as the rolling contacts of the steerable units 110 merely roll along the rolling contacts of steerable unit 106 parallel to its axis of rotation.

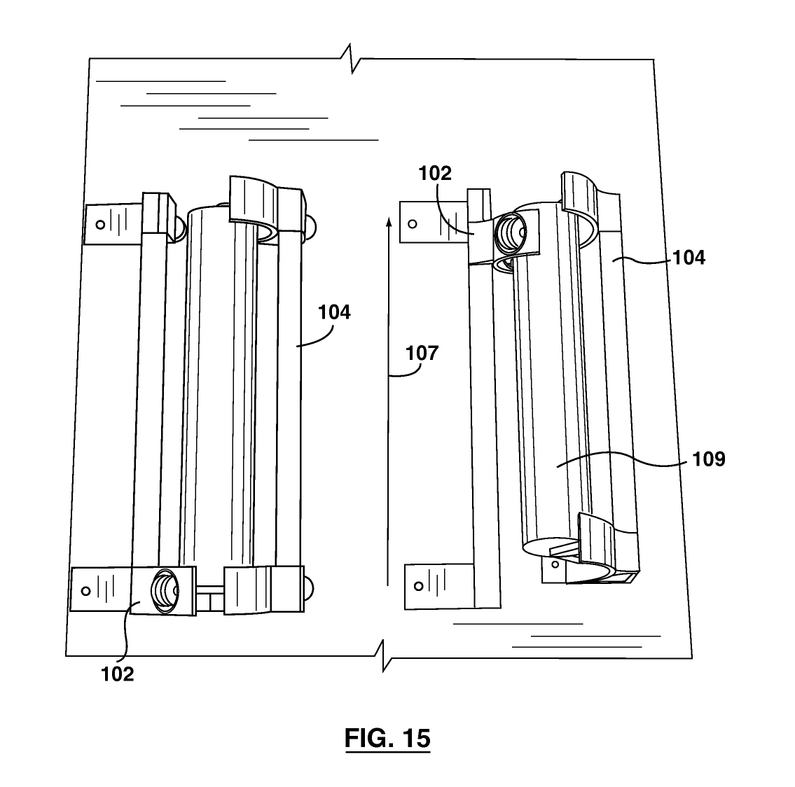

Perspective views of the operation of the 0 degree orientation are shown in FIGS. 14 and 15.

As can be seen in FIG. 15, movement of the chassis 102 a distance 107 in the 0 degree configuration causes no movement of the land 104. That is, none of the power applied to the chassis 102 is transferred to the land 104.

In another embodiment, several the linear CVTs described above may be arranged in a circular configuration to provide a toroidal CVT.

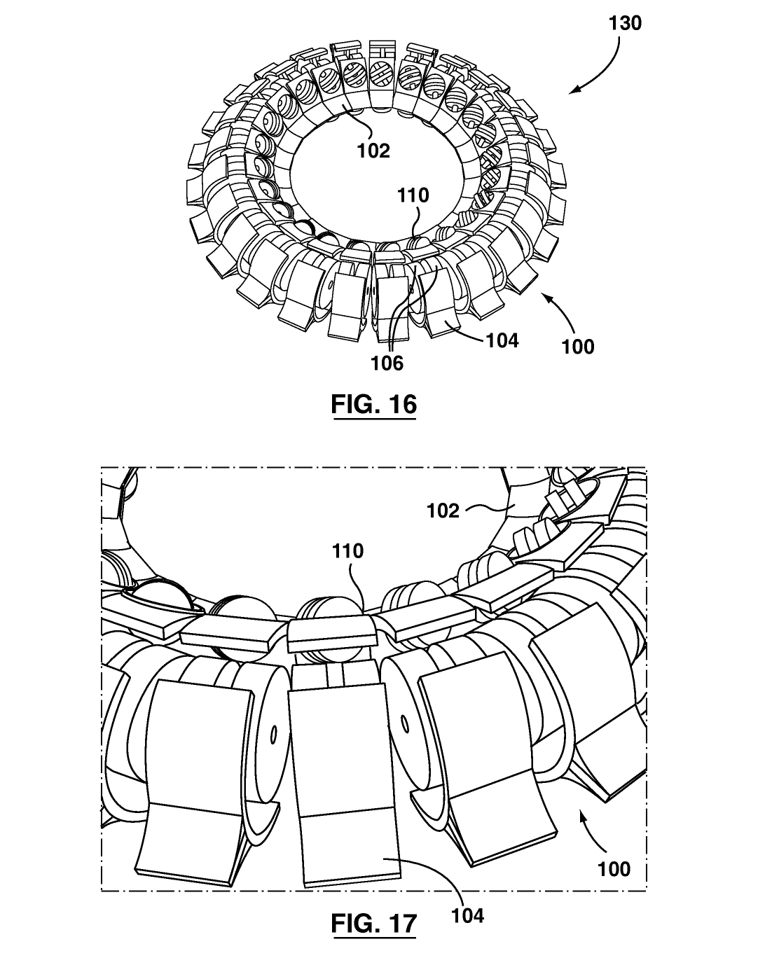

FIG. 16 shows a circular configuration of 25 linear CVT segments 100 identical to the linear CVT segment 100 shown in FIGS. 7 to 15 forming a circular CVT 130 in accordance with an embodiment of the present invention. The linear CVT segments are configured so that chassis's of each segment are interconnected to form a solid ring and the steerable units 110 and 106 are sized so that the rolling contacts of steerable units 110 are constantly, or nearly constantly, in rolling contact with the rolling contacts of steerable units 106. In this way, the steerable units as a whole form a segmented toroidal rollable.

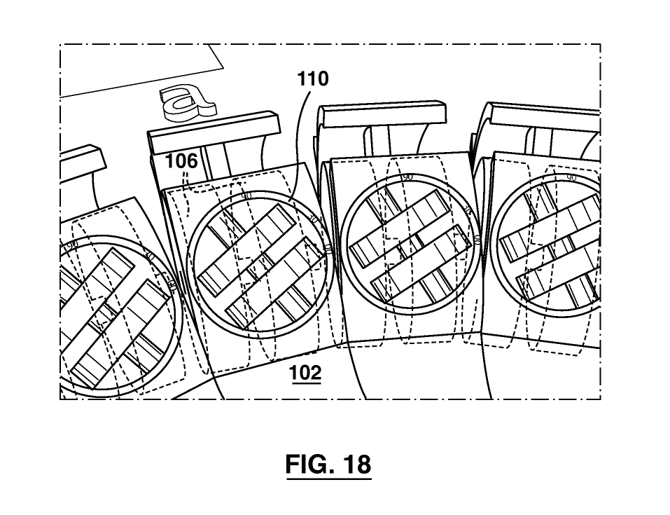

FIGS. 17 and 18 provide zoomed in views showing the details of individual segments. In the illustrated example, the rolling contacts are arranged in a 30 degree orientation, but can be steered to any multiple of any angular orientation between 0 and 90 degrees (0 to 1:1 gear ratio).

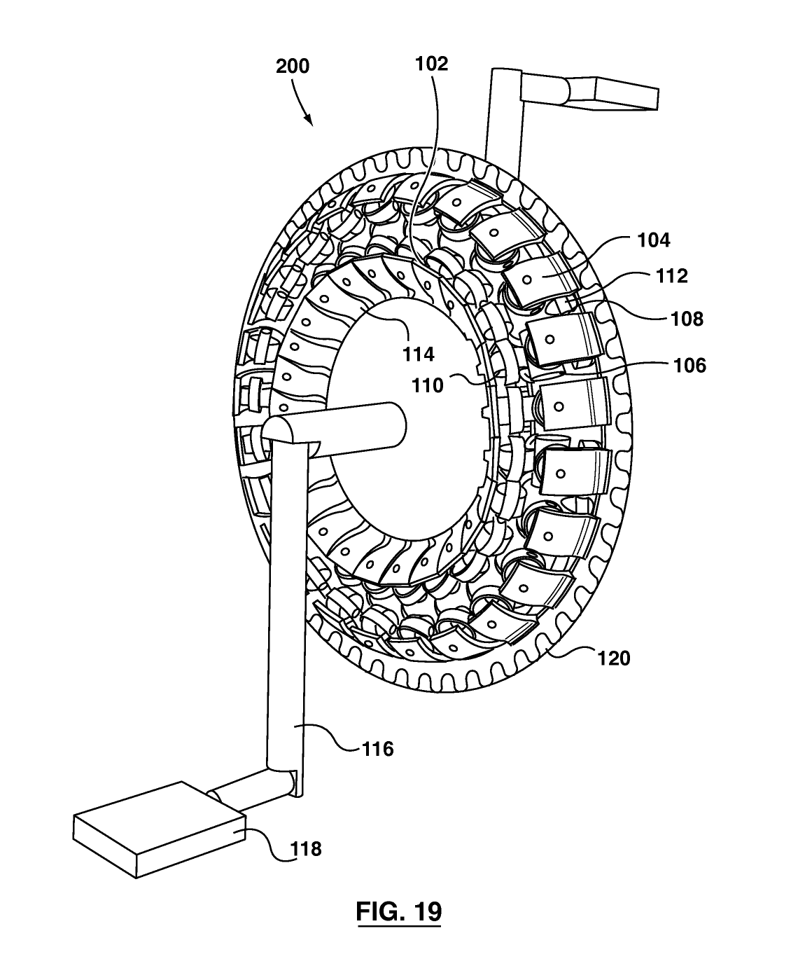

FIG. 19 is an illustration of a circular transmission system 200 that, for illustrative purposes only, has been designed for use on a bicycle. While this particular example is described in the context of a bicycle transmission, it should be clear that the concepts and aspects of the design are readily applicable to any mechanical system where it is desirable to vary mechanical power's transmission.

The circular CVT system 200 of this example includes 25 linear CVT segments, each including a chassis segment 102, a land segment 104 and a steerable unit 106. The steerable unit 106 is retained in a berth 108 in the land segment 104 by rolling contacts 112 that both have an axis of rotation that is fixed in place parallel to the axis of rotation of the rollable segment. Each chassis segment 102 includes a pair of steerable units 110 each having rolling contacts, which, when oriented in a 90 degree orientation provide a 1:1 gear ratio.

The 25 chassis segments are connected to form a solid ring shaped chassis that is connected at its center to a pair of crank arms 116. Each crank arm 116 has a respective pedal 118 attached thereto. Each of the land segments 104 is connected on its outer surface to a sprocket 120. On a bicycle, the sprocket 120 would typically be used to drive a chain connected to some type of gear assembly on the rear wheel of the bicycle in order to transfer power to the rear wheel.

The toroidal rollable formed by the rollable segments 106 is retained in place between the land segments 104 and the chassis segments 102. The rollable segments 106 do not translate relative to the land segments 104.

However, if the rolling contacts are oriented at any angular orientation less than a 90 degree orientation, then circular movement of the chassis ring formed by the chassis segments 102 due to pedalling of the pedals 118 will cause circular translational movement of the chassis ring relative to the toroidal rollable in a less than 1:1 relationship.

That is, at any angular orientation less than the 90, and greater than 0, degree orientation where the gear ratio is less than 1:1, and greater than 1:0, it will require more than one revolution of the pedals and the chassis ring to produce one rotation of the land segments 104.

The angular orientation of the rolling contacts of steerable units 110 would thus be varied in order to vary the gear ratio of the transmission system.

An angular orientation of 0 degrees is a 1:0 relationship, and produces no rotation of the land segments 104.

The circular CVT system 200 includes a steering system 114 that allows each of the rolling contacts of the steerable units 110 to be simultaneously steered to a new angular orientation relative to the toroidal rollable formed by the rollable segments 106. In the illustrated example, each steerable wheel is mounted on a suspension on the interior surface of each chassis segment and each suspension has a rotational axle that protrudes through the chassis into the central portion of the transmission system. In one embodiment, the steering system 114 is implemented using a wire wrapped around each rotational axles of the suspension in which the steerable units are mounted. By applying tension to the wire the rotational axles can be rotated, thus turning the steerable units 110 and the angle of the rolling contacts. This type of steering system is merely one example of a steering system that may be used in some embodiments of the present invention. A person of ordinary skill in the art will appreciate that there are a multitude of potential steering mechanisms, including, but not limited to, other forms of linkage, a radio frequency device or electric motors, that may be utilized to steer zero turning radius rolling contacts, such as the rolling contacts of steerable units 110 shown in FIG. 19.

In one embodiment, the steerable units described above can be provided on the surfaces of interconnecting shafts or cylinders to provide a connecting system. In particular, the outer surface of one cylinder can be provided with the steerable units, which mate with corresponding steerable units provided on the inner surface of a second cylinder.

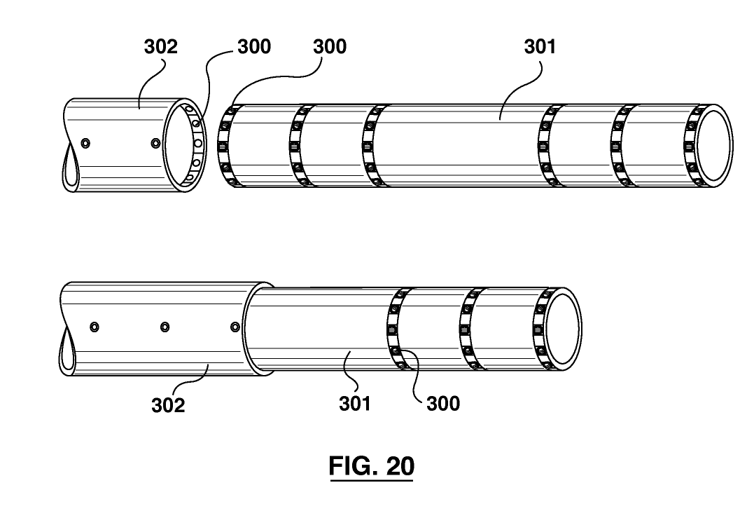

Although any number of steerable units can be provided on either surface and in any pattern, FIG. 20 shows, for illustrative purposes only, an arrangement where the steerable units (300) are provided on the outer surface of a first cylinder (301) in concentric rows encircling the first cylinder (301). In this arrangement, corresponding concentric rows of steerable units (300) are provided on the inner surface of a second cylinder (302) so that when the first cylinder (301) is engaged with the second cylinder (302) the rolling contacts of the steerable units (300) of each surface contact one another.

In some embodiments, one, two, three, four, five, six, seven, eight, nine, ten, or multiplies thereof, concentric rows of steerable units (300) can be applied to the surfaces of the first and second cylinders (301 and 302). Moreover, a series of cylinders can be interconnected to one another by providing steerable units (300) on the inner and/or outer surfaces of the cylinders (301 and 302). For example, taking the first and second cylinders of FIG. 20 as an illustration, the outer surface of the first cylinder, in the vicinity of the end that does not engage the second cylinder, may contain the steerable units (300) of the present invention. Likewise, the second cylinder (302) in the vicinity of the end of cylinder that does not engage the first cylinder might also be provided with steerable units (300) on the outer surface of the cylinder (302).

In addition to the providing the velocity and power modifying effects described above, the steerable units (300) in this arrangement can be used as a mechanism to lock the two cylinders together. In this embodiment, the rolling contacts of the steerable units (300) of the first cylinder (301) and the second cylinder (302) are first aligned so that the rolling contacts travel freely over one another. This would be analogous to the arrangement of steerable units (1) shown in FIG. 4a. Alternatively, the angle of rolling contacts of the steerable units (300) on either the first (301) or second cylinder (302) can be fixed and the rolling contacts of the steerable units (300) on the other cylinder can be free to rotate in any direction to allow the cylinders (301, 302) to become engaged. Further still, one or more of the rows of steerable units (300) on either the first or second cylinders (301, 302) can have the angle of the rolling contacts fixed and the other rows free to rotate. Providing the rows of steerable units in different configurations can permit or limit movement of the cylinders (301, 302) along the longitudinal axis thereof, and/or allow or limit the rotational movement of the cylinders (301, 302) with respect to one another.

In one embodiment, once the first cylinder (301) is inserted into and engaged with the second cylinder (302), the rolling contacts of steerable units (1′) (300) on the outer surface of the first cylinder (301) and the inner surface of the second cylinder (1) (302) are rotated 90 degrees in opposite directions from their starting positions. This arrangement is analogous to that shown in FIG. 4d, described above. When in the locked position, movement along the longitudinal axis of the connected cylinders 301 and 302 is prevented.

The steerable units of the present invention can also be applied to at least some of the circumferential surfaces of the discs, or gears, in an epicyclic wheel system to provide control over the output velocity of the output shaft.

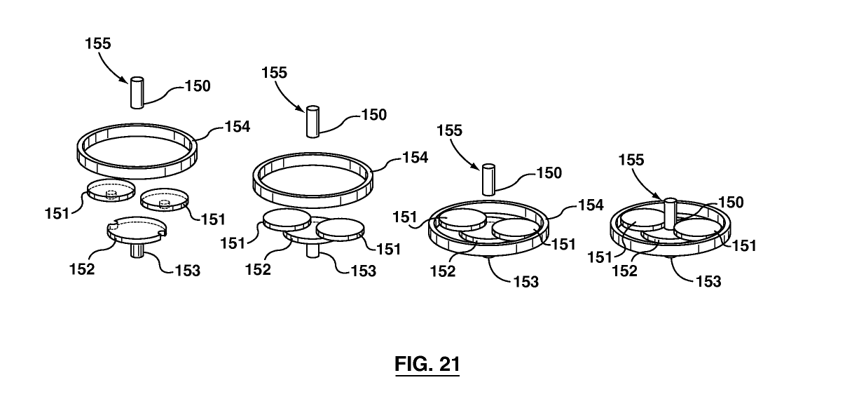

With reference to FIG. 21, a typical epicyclic gear system comprises an innermost gear, which is commonly referred to as a Sun gear (150) or Sun disc. The Sun gear (150) comprises an output shaft (155) that outputs an output velocity. The Sun gear (150) is meshed with the Planet gears (151) revolving around it.

The Planet gears (151), or planet discs, are rotatable on an axle fixed to a Planet carrier (152) that rotates on the same axis of rotation as the Sun gear (150). The planet carrier (152) comprises an input shaft (153) that receives an input velocity.

The outermost gear, commonly referred to as the Annulus gear (154), or Annulus disc, is typically a hollow ring with teeth facing inward, which also rotates on the same axis of rotation as the Sun gear (150). The Annulus gear (154) is meshed to the Planet gears (151) within it.

Since each Planet gear (151) meshes with both the Sun gear (155) and the Annulus (154), the diameter of the Annulus (154) must be the sum of the diameter of the Sun gear (150) plus the diameter of the planet gear (151) on each side of the Sun gear (150).

According to an embodiment of the present invention, at least the circumferential surfaces of the Planet discs (151) are provided with the steerable units (1) described above. In a preferred embodiment, the circumferential surface of the Sun disc (150), the inner facing surface of the Annulus (154) and the axle(s) and drive shaft hollows inner circumferential surfaces of the Planet carrier (152) all comprise the steerable units described above. Further still, the surface of the input and output shafts (153 and 155) can include the steerable units.

In operation, the input shaft (153) of the Planet carrier (152) rotates with an input velocity. This velocity transmits through the Planet discs (151) by having the Planet carrier (152) translate the Planet discs (151). In most cases, a stem descending from the Planet discs (151) engages the Planet carrier (153) causing the translational velocity of the Planet carrier (153) to be transmitted to the Planet discs (151).

In this example, modification and control of the amount of velocity transferred throughout the system can be achieved by the modifying the angles of the rolling contacts of the steerable units on the Annulus (154).

In some cases, the diameter of the Sun disc (150) is equal to the diameter of the output shaft (155). As such, the Sun disc (150) and output shaft (155) may appear as a column, as shown in FIG. 21.

A number of epicyclic wheel systems can be interconnected to produce a velocity modifier. In this type of system, each individual epicyclic wheel system acts as a stage in the velocity modifier. Each stage in the modifier has a velocity modifying factor and the input of each subsequent stage in the system is connected with the output of an immediately preceeding stage. In other words, the output shaft of one stage of the velocity modifier is directly connected to the input shaft of the subsequent stage in the system. This connection can be in the form of a coupling that connects the output shaft of one stage to the input shaft of the subsequent stage, or the output shaft can be the input shaft of the subsequent stage.

In other embodiments, the Sun disc's output shaft of one stage of the velocity modifier can be connected to an orthogonal disc connected to the Planet carrier's drive shaft hollow of a subsequent stage.

The present invention has been described with regard to preferred embodiments. However, it will be obvious to persons skilled in the art that a number of variations and modifications can be made without departing from the scope of the invention as described herein.

1. A steerable unit for use in a machine, said steerable unit comprising:
an annulus for insertion into a surface of the machine;
an axle transversing the annulus; and
one or more rolling contacts positioned on the axle,
wherein the angle of the one or more rolling contacts in relation to the surface of the machine is controllable.

2. The steerable unit according to claim 1, wherein the angle of the one or more rolling contacts in relation to the surface of the machine is controlled by rotating the axle about the center of the annulus.

3. The steerable unit according to claim 1, wherein the angle of the one or more rolling contacts in relation to the surface of the machine is controlled by rotating the annulus within the surface of the machine.

4. The steerable unit according to claim 1, wherein the circumferential surface of the one or more rolling contact is capable of frictionally engaging another surface of the machine.

5. The steerable unit according to claim 1, further comprising a second annulus positioned within the annulus and slidable against the inner surface thereof, wherein the axle is attached to the inner surface of the second annulus.

6. The steerable unit according to claim 1, wherein the angle of the one or more rolling contacts in relation to the surface of the machine is controlled by linkages, a radio frequency device or electric motors.

7. The steerable unit according to claim 6, wherein the linkages are ropes or pulleys.

8. The steerable unit according to claim 4, wherein the one or more rolling contacts are made from synthetic or natural rubber.

9. The steerable unit according to claim 1, wherein the one or more rolling contacts are selected from spheres, wheels and cylinders.

10. The steerable unit according to claim 1, wherein the one or more rolling contacts positioned on the axle rotate about the axle.

11. The steerable unit according to claim 1, wherein the rolling contacts and axle form a unitary structure and the axle rotates about a plane formed by the annulus.

12. A surface comprising one of more of the steerable units according to claim 1.

13. A connecting system comprising:
a first partially hollow cylinder dimensioned to receive a second partially hollow cylinder, wherein the inner facing surface of the first partially hollow cylinder comprises a plurality of steerable units according to claim 1; and wherein the outer facing surface of the second partially hollow cylinder comprises a plurality of steerable units according to claim 1, whereby when the second partially hollow cylinder is engaged with the first partially hollow cylinder the plurality of steerable units on the inner facing surface of the first partially hollow cylinder frictionally engage the plurality of steerable units on the outer facing surface of the second partially hollow cylinder.

14. The connecting system according to claim 13, wherein the plurality of steerable units on the inner facing surface of the first partially hollow cylinder are positioned in a row around the circumference of the inner facing surface.

15. The connecting system according to claim 13, wherein the plurality of steerable units on the outer facing surface of the second partially hollow cylinder are positioned in a row around the circumference of the inner facing surface.

16. The connecting system according to claim 13, wherein the outer facing surface of the partially hollow first cylinder comprises a plurality of steerable units according to claim 1.

17. The steerable unit according to claim 1 for use in an epicyclic wheel system, said epicyclic wheel system comprising:
a sun disc comprising an output shaft;
a planet carrier comprising an input shaft;
a set of one or more planet discs that receive rotational input from the planet carrier and engage the sun disc to rotate the output shaft; and
an annulus surrounding the sun disc, planet carrier and the one or more planet discs, said annulus is dimensioned to interact with the circumferential surface of the planet discs,
wherein at least the circumferential surface of the one or more planet discs and the inward facing surface of the annulus comprise a plurality of the steerable units.

18. The steerable unit of claim 17, wherein the surface of the sun disc comprises a plurality of the steerable units.

19. The steerable unit according to claim 1 for use in a velocity modifier, said velocity modifier comprising:
a plurality of interconnected epicyclic wheel systems as defined in claim 17 each acting as a stage in the velocity modifier, wherein each stage has a velocity modifying factor and the input of each subsequent stage in the system is connected with the output of an immediately preceeding stage.

20. The steerable unit according to claim 1 for use in a continuously variable transmission, said continuously variable transmission comprising:
a berth;
a power input chassis configured to move in a first chassis direction in response to an input of mechanical power, and connecting to the berth;
a rollable surface having an axis of rotation about which the rollable surface is rotatable, the rollable surface having a continuously variable angular orientation relative to the force direction of mechanical power input; the axis of rotation of the rollable surface may be oriented as substantially parallel to the first direction in which the power input chassis moves in response to the input of mechanical power, and connecting to the berth;
a steerable rolling contact between the power input chassis and the rollable surface comprising the steerable unit, the steerable rolling contact having a continuously variable angular orientation relative to the force direction of mechanical power input, and connecting to the berth;
a power output land configured to move in a first land direction in response to an input of mechanical power, and connecting to the berth;
wherein the berth is rotatably configured to conduct mechanical power between a power input to a power output indifferent to whether the input and output points are the rollable surface, steerable rolling contact, chassis or land.
